(19) United States
(12) Patent Application Publication
(10) Pub. No.: US 2023/0340638 A1
(43) Pub. Date: Oct. 26, 2023

(54) SYSTEM AND METHOD FOR EXTRACTION OF ELEMENTS FROM AN AQUEOUS SOLUTION

(71) Applicant: PRODUCED WATER ABSORBENTS INC., Houston, TX (US)

(72) Inventors: Amanda REICHERT, Houston, TX (US); Caleb SMATHERS, Houston, TX (US); Peter M. SMITH, Houston, TX (US)

(73) Assignee: PRODUCED WATER ABSORBENTS INC., Houston, TX (US)

(21) Appl. No.: 18/303,632

(22) Filed: Apr. 20, 2023

Related U.S. Application Data
(60) Provisional application No. 63/332,968, filed on Apr. 20, 2022.

(51) Int. Cl. C22B 26/12; C22B 3/24; C22B 3/44

(52) U.S. Cl. CPC C22B 26/12; C22B 3/24; C22B 3/44

(57) ABSTRACT

The present disclosure includes systems and methods for extracting a target element, such as lithium, from a brine. For example, some aspects include a method of extracting lithium including mixing a first brine with an extraction agent to form a first solution having a lithium complex, the lithium complex including lithium bound to the extraction agent. The method can further include extracting the lithium from the first solution and recycling the extraction agent to be used in a further extraction process. In some aspects, extracting the lithium from the first solution includes adsorbing, via an adsorbent media, the lithium complex from the first solution, removing the lithium complex from the adsorbent media, and separating the lithium from the extraction agent in the lithium complex.

### PRIORITY

This application claims the benefit of U.S. Provisional application 63/332,968 filed Apr. 20, 2022. This application claims priority to and incorporates herein by reference the above-referenced application in its entirety.

### FIELD OF INVENTION

The present invention relates generally to methods and systems for extracting metals from an aqueous solution, and more specifically, to the extraction of lithium from a brine via adsorption into an organosilica porous matrix and desorption via a recycled liquid solvent.

### BACKGROUND

Lithium, and other alkali earth metals, are used in a variety of industries and are an important component of the manufacture of ceramics, glass, batteries, polymers, metals, and pharmaceuticals, among other things. Currently, lithium can be extracted via two methods. The first is mining, which requires building a mine, extracting the clay or ore, and separating the metal through a complex process. The second is to pump underground water deposits, known as brine, to the surface, where the lithium can be extracted.

Current methods of lithium extraction from brines are problematic. For example, the most widely used method for recovering lithium is to pump brine into evaporation ponds and allow the sun to evaporate the water from the Lithium brine and concentrate the lithium. This process usually takes several months to a few years to be completed and requires large areas of land for the evaporation ponds. Another drawback to this process is the environmental impact caused in the region that is already water-scarce areas, causing water depletion.

Some methods, such as that described in CN106902781A, use specifically designed adsorption media with active sites to target lithium and, while some of these adsorption media are effective, the regeneration or recovery of the lithium from the adsorption media is inefficient. For example, this process utilizes backwashes with different pH water to recover the lithium and requires significant volumes of water and consumable chemicals must be used to recover and concentrate the lithium.

Other methods include utilizing specifically tailored extractants diluted in an organic phase that can extract the lithium from the water. For example, Tributyl Phosphate and Kerosene are commonly used for lithium extraction. However, this recovery process requires high volumes of the specialty chemical diluent (e.g., kerosene). Additional disadvantages of these methods include the size of the equipment required for liquid/liquid separations (aqueous and organic) and the use of consumable chemicals, such as acids and bases. The liquid phase separation process can also lead to brine water carry over into the diluent, creating issues with the final lithium product recovered, and can destroy the integrity of the diluent and extraction agent. Conversely, chemical diluent, is not always completely separated from the aqueous water phase, thus contaminating the water phase.

Some other methods call for supercritical CO2 (SCO2) to extract lithium from brine. However, these methods also require large volumes of liquid CO2 for effective lithium recovery and the operating pressure and temperature to reuse the CO2 significantly increases the system cost, size, weight, and carbon footprint.

### SUMMARY

Thus, there exist a need for processes and system that can extract elements, such as lithium, from brines that are both time-sensitive, cost-efficient, and environmentally friendly. Some aspects of the present disclosure provide improvements in lithium extraction from brines. For example, some aspects of this disclosure include a method of extracting lithium. Some such methods include mixing a first brine having lithium with an extraction agent to form a first fluid having a lithium complex that includes lithium bound to the extraction agent, extracting the lithium from the first fluid, and recycling the extraction agent, the adsorbent media, or both. In some configurations, extracting the lithium includes adsorbing, via an adsorbent media, the lithium complex from the first fluid, removing the lithium complex from the adsorbent media, and separating the lithium from the extraction agent. Although described below as lithium extraction in illustrative example, the system and process below can be utilized for other metals, such as rare earth metals or elements, alkali metals, or other elements.

In some aspects, the method can further include mixing a second brine having lithium with the recycled extraction agent to form a second fluid having the lithium complex. In such configurations, extracting the lithium from the second fluid may include adsorbing, via the adsorbent media, the lithium complex from the second fluid, removing the lithium complex from the adsorbent media, and separating the lithium from the extraction agent in the lithium complex. In some methods, the recycled extraction agent and the adsorbent media can be further recycled in an additional extracting step. In some of the present methods, extracting lithium is performed without a diluent, such as kerosene.

In some methods, the adsorbent media includes a mesoporous silica media. Additionally, or alternatively, the extraction agent can include an acidic extractant or a neutral extractant. In some of the present methods, removing the lithium complex from the adsorbent media can include introducing the adsorbent media to a solvent to displace the lithium complex from the adsorbent media. Some methods can further include separating the adsorbent media from the solvent and lithium complex and evaporating the solvent from the lithium complex. Some of the present methods include recycling the solvent to be used in a further extracting step. As a non-limiting example, the solvent can have a vapor pressure that is greater than a vapor pressure of the extracting agent. In some configurations, separating the lithium from the extraction agent in the lithium complex includes introducing the lithium complex to an acid.

Some aspects of the present methods include a method for recovering lithium from groundwater. For example, some of the present methods include receiving, at a first vessel, a first brine having lithium, receiving, at the first vessel, an extracting agent, and forming, at the first vessel, a first solution having a first composition that includes the lithium and the extracting agent. Some of the methods include introducing, at a second vessel, the first solution to a plurality of porous silica adsorbents such that the first composition is adsorbed onto the porous silica adsorbents and removing the first composition from the porous silica adsorbents. Some methods include separating the lithium from the extracting agent in the first composition and transporting the extracting agent to the first vessel. The separated lithium can be further processed.

In some aspects, the methods can include receiving, at the first vessel, a second brine having lithium, forming, at the first vessel, a second solution having the first composition, and extracting the lithium from the first composition. In some configurations, the extracting agent is transported back to the first vessel. In some aspects, removing the first composition from the porous silica adsorbents includes mixing, at the second vessel, the porous silica adsorbents with a solvent to form a second solution and transferring the second solution to a third vessel. In some such configurations, the method may include the steps of evaporating, at the third vessel, the solvent to form a third solution and recycling the solvent. The third solution can include the first composition and a concentration of the first composition in the third solution is greater than 98%. In some of the above methods, separating the lithium from the extracting agent in the first composition includes modifying a pH of the first composition.

Some aspects of the present disclosure include a system for extracting lithium. For example, the system can include a first vessel, a second vessel, a third vessel, a fourth vessel, a first return line, or combination thereof. In some aspects, the first vessel includes an inlet configured to receive a first brine having lithium and an extractant and a mixer configured to mix the first brine with the extractant to form a first solution having a lithium complex. The lithium complex includes lithium bonded to the extractant. In some configurations, the second vessel can include an inlet configured to receive the first solution from the first vessel, a porous silica media configured to adsorb the lithium complex from the first solution, and a first outlet configured to discharge the first solution after the lithium complex is adsorbed on the porous silica media. Some configurations of the second vessel include a second outlet configured to discharge a second solution having the lithium complex and a solvent.

In some aspects, the third vessel can include an inlet configured to receive the second solution from the second outlet of the second vessel and a first outlet configured to discharge the lithium complex from the third vessel. In some such configurations, the third vessel can include a second outlet configured to discharge the solvent from the third vessel. The fourth vessel may include an inlet configured to receive the lithium complex from the first outlet of the third vessel and a first outlet configured to discharge the extractant from the lithium complex. Some configurations of the fourth vessel include a second outlet configured to discharge the lithium from the lithium complex. In some aspects, a first return line is coupled to the first outlet of the first vessel and in fluid communication with the first vessel. The first return line can be configured to recycle the extractant from the fourth vessel to the first vessel. In some of the present systems, the first vessel is configured to receive the extractant from the first return line and receive a second brine having lithium from a fifth vessel. In some aspects, the system can include a second return line coupled to the second outlet of the third vessel and in fluid communication with the second vessel, the second return line configured to recycle the solvent from the third vessel to the second vessel.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified, e.g., substantially 90 degrees includes 90 degrees and substantially parallel includes parallel), as understood by a person of ordinary skill in the art. In any disclosed configuration, the term “substantially” may be substituted with “within [a percentage] of ” what is specified, where the percentage includes 0.1, 1, 5, and 10 percent.

Further, an apparatus or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any configuration of any of the apparatuses, systems, and methods can consist of or consist essentially of—rather than comprise/include/have—any of the described steps, elements, and/or features. Thus, in any of the claims, the term “consisting of ” or “consisting essentially of” can be substituted for any of the open-ended linking verbs recited above, in order to change the scope of a given claim from what it would otherwise be using the open-ended linking verb.

The feature or features of one configuration may be applied to other configurations, even though not described or illustrated, unless expressly prohibited by this disclosure or the nature of the configurations.

Some details associated with the configurations described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the configuration depicted in the figures.

FIG. 1 is an example of a diagram of a system of the present invention.

FIG. 2 is an schematic box diagram of the system of FIG. 1.

FIG. 3 is another example of a diagram of a system of the present invention.

FIG. 4 illustrates a flow diagram of an example of a method of extracting a target element.

FIG. 5 is a graph of a first example of Lithium recovery according to the present disclosure.

FIG. 6 is a graph of a second example of Lithium recovery according to the present disclosure.

FIG. 7 is a graph of a third example of Lithium recovery according to the present disclosure.

### DETAILED DESCRIPTION

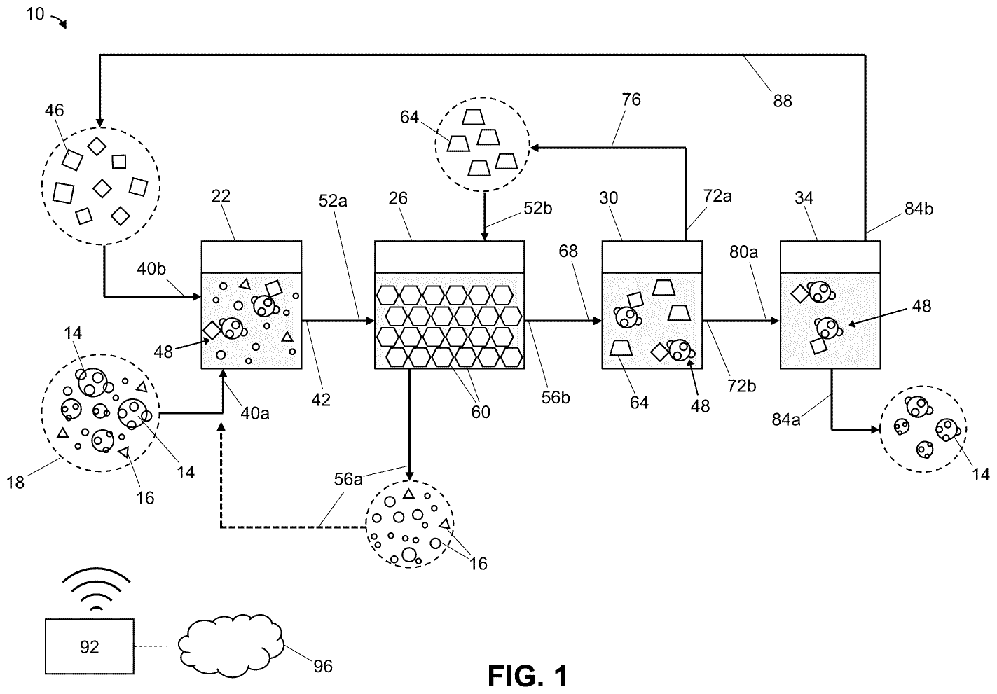

Referring now to the drawings, and more particularly to FIG. 1, shown therein and designated by the reference numeral 10 is a system for extracting elements, such as alkali metals from an aqueous solution. As an illustrative example, system 10 may be utilized for the extraction or separation of lithium 14 from a brine 18 (e.g., groundwater). In some configurations, brine 18 may be a liquid having lithium 14 (e.g., in the form of a salt) along with other elements, minerals, and components 16 (referred to hereafter as “impurities” 16). In some configurations, impurities may include sodium, potassium, calcium, magnesium, borates, sulfates, silica, manganese, or other elements or compounds. As should be understood, system 10 is not limited to solely extracting lithium 14 and could be used to extract or separate other elements (e.g., rare earth metals, alkali metals, or the like) from other solutions.

System 10 includes a plurality of vessels configured to process fluids (e.g., liquids). For example, as depicted in FIG. 1, system 10 may include a mixing vessel 22, an adsorption vessel 26, and one or more separation vessels, such as a first separation vessel 30, and a second separation vessel 34. Each vessel defines a chamber and one or more inlets and outlets in communication with the chamber to move the fluids within system 10. Although not shown, system 10 can include an actuation system (e.g., positive displacement pump, centrifugal pump, or other pumps, turbines, compressors, motors, or the like) or other known components in fluid processing systems, such as valves, regulators, flowmeters, or the like.

Mixing vessel 22 can include one or more inlets (e.g., 40) configured to receive brine 18 and an extractant 46 (e.g., extractant agent, chelate, or the like) and an outlet 42. As depicted, mixing vessel 22 includes two inlets: a first inlet 40a in communication with brine 18 and a second inlet 40b in communication with extractant 46. However, in other configurations, mixing vessel 22 can include a single inlet or more than two inlets. In some configurations, first inlet 40a is in communication with a first reservoir, such as an underground well or a reservoir tank, that includes brine 18. Additionally, or alternatively, second inlet 40b may be in communication with a second reservoir that includes extractant 46. In some configurations, extractant 46 includes an acidic extractant such as a phosphoric extractant, phosphinic extractant, phosphonic extractant, or other cation exchangers, a neutral extractant, such as crown ethers, solvating extractants, or the like. As specific examples, extractant 46 may include Cyanex® extractants, mono-2-ethylhexyl-(2-ethylhexyl) phosphonic acid (MEHEHP) extractants, di-2-ethylhexyl phosphoric acid (DEHPA) extractants, 2-[(1Z)-1-(hydroxyamino)ethyl]-4-nonylphenol (LIX 84I) extractants, tri-n-butylphosphate (TBP) extractants. In other examples, extractant may change based on the element to be extracted and in another specific example Lanthanum (e.g., 14) can be utilized with di-2-ethylhexyl phosphoric acid (DEHPA) extractants. In yet another example, samarium or cobalt (e.g., 14) can be utilized with MEHEHP, DEHPA, or TBP extractants.

As shown, brine 18 and extractant 46 are combined within mixing vessel 22 such that the extractant interacts with lithium 14 within the brine. For example, lithium 14 may form a chemical bond with extractant 46 to form a compound 48 (referred to herein as a lithium complex or lithium-extractant agent complex). Lithium complex 48 can include at least one lithium atom chemically bonded to extractant 46. Brine 18 and extractant 46 can be added to mixing vessel 22 simultaneously or sequentially and are mixed sufficiently to form a first solution having lithium complex 48. To illustrate, in some configurations, mixing vessel 22 can including a mixer or agitation device (e.g., stirrer, jets, or other components configured to induce fluid mixing) configured to mix extractant 46 and brine 18 to form the lithium complex 48. The first solution may then be transferred (e.g., discharged) from mixing vessel 22, via outlet 42, to another vessel, such as adsorption vessel 26.

Adsorption vessel 26 includes one or more inlets (e.g., 52), one or more outlets (e.g., 56), and is configured to accommodate an adsorbent media 60. At least one of the inlets of adsorption vessel is configured to receive lithium complex 58. For example, adsorption vessel 26 may include a first inlet 52a in communication with outlet 42 of mixing vessel 22 to receive the first solution from the mixing vessel. In the depicted configuration, adsorption vessel 26 may include a second inlet 52b configured to receive a solvent 64, however, in other configurations, the solvent or other additional solutions may be introduced to the adsorption vessel 26 via first inlet 52a.

As shown, adsorbent media 60 may be positioned within adsorption vessel 26 and is configured to interact with lithium complex 48. To illustrate, lithium complex 48 may be adsorbed onto adsorbent media 60 while the remainder of the first solution (e.g., water and impurities 16) move freely within adsorption vessel 26. In this way and others, lithium 14 can be separated from brine 18 and associated impurities 16. In some configurations, adsorbent media 60 includes a porous or mesoporous silica media, such as a plurality of porous silica grains. As a specific example, adsorbent media 60 can include the composition described in U.S. Pat. No. 7,790,830, which is incorporated by reference herein. In another example, adsorbent media 60 can include Osorb® media, manufactured by Aqunex Technologies.

After lithium complex 48 is adsorbed onto adsorbent media 60, the remainder of the first solution (e.g., impurities 16) may be transferred out of adsorption vessel 26 via a first outlet 56a. In some configurations, first outlet 56a can be in communication with an inlet (e.g., 40a) of mixing vessel 22 to transfer the outlet water back to the mixing vessel. To illustrate, a portion of lithium 14 from brine 18 may not be bonded to extractant 46 or adsorbed to adsorbent media and, therefore, the outlet water can have a concentration of lithium. This outlet water can then by cycled back through mixing vessel 22 and adsorption vessel 26 to extract a remainder of lithium 14. This cycle can be repeated any number of times, such as for example, for a predetermined number of cycles, until a lithium concentration of the outlet water is less than a threshold, or the like. In such configurations, the outlet water can act as a second brine, as described herein.

Solvent 64 can be introduced into adsorption vessel 26 (e.g., via second inlet 52b) to form a second solution. Solvent 64 may include a light hydrocarbon (e.g., propane, butane, other C3-C4 hydrocarbons, or combination thereof), CO₂ liquid, Halogenated hydrocarbons, Oxygenated hydrocarbons, such as acetone, MeOH, IPA, butanol, C4+ alcohols, or the like. Solvent 64 can interact with the adsorbed lithium complex 48 to release the lithium complex from adsorbent media 60. For example, a liquid solvent 64 can contact adsorbent media 60 and dissolve lithium complex 48 to form a second solution. The second solution—including lithium complex 48 and solvent 64—can then be transferred from adsorption vessel 26 for further processing. For example, the second solution may be transferred from adsorption vessel 26, via a second outlet 56b, to another vessel, such as first separation vessel 30. Adsorbent media 60 can remain within adsorption vessel 26 and can be reused in subsequent extraction or separation processes.

First separation vessel 30 can include one or more inlets (e.g., 68) and one or more outlets (e.g., 72) configured to transfer fluid between the first separation vessel. As shown, first separation vessel 30 includes a first inlet 68 in communication with second outlet 56b of adsorption vessel 26 and is configured to receive lithium complex 48 and solvent 64 from the adsorption vessel. First separation vessel 30 can be configured to separate lithium complex 48 from solvent 64. For example, first separation vessel 30 can be configured to evaporate solvent 64 to separate the solvent from lithium complex 48. In some such configurations, first separation vessel 30 (e.g., scrubber vessel) can include or be coupled to one or more components (e.g., actuation system, pressure control valve, or the like) that are configured to change a pressure or temperature of the fluid (e.g., the second solution) within the first separation vessel. After lithium complex 48 and solvent 64 have been separated, the solvent can be transferred from first separation vessel 30, via a first outlet 72a, and a third solution—having the lithium complex—can be transferred from the first separation vessel, via a second outlet 72b, for further processing.

In some configurations, first separation vessel 30 may include a return line 76 that is configured to recycle solvent 64. Return line 76 can be in communication with first separation vessel 30 and adsorption vessel 26 to move fluid between the two vessels. As depicted, solvent 64 can be transferred out of first separation vessel 30, via first outlet 72a, to return line 76, and transferred into adsorption vessel 26. Although not depicted for clarity, return line 76 can include additional components for processing fluid, such as solvent 64. For example, return line 76 can include or be coupled to a reservoir that is configured to store the fluid and selectively release the stored fluid into adsorption vessel 26 at a desired time. As another example, return line can include or be coupled to pressurized device that is configured to change a pressure of the fluid within return line. To further illustrate, in a configuration in which solvent 64 is evaporated from first separation vessel, return line 76 may increase pressure (or reduce temperature) to return the solvent to a liquid phase.

Second separation vessel 34 can include one or more inlets (e.g., 80) and one or more outlets (e.g., 84) configured to transfer fluid between the second separation vessel. As shown, second separation vessel 34 includes a first inlet 80a in communication with second outlet 72b of first separation vessel 30 and is configured to receive the third solution (e.g., lithium complex 48) from the first separation vessel. In some configurations, lithium complex 48 can make up at least a majority of the third solution. For example, a concentration of lithium complex 48 within the third solution can be greater than 90 percent, such as 92, 93, 94, 95, 96, 97, 98, or 99%. In some such configurations, the third solution can consist of lithium complex 48 and water.

Second separation vessel 34 can be configured to separate lithium complex 48 into lithium 14 and extractant 46. In some configurations, second separation vessel 34 can be configured to modify a pH of the third solution. As an illustrative example, an eluent may be mixed with lithium complex 48 to separate lithium 14 from extractant 46. To further illustrate, the eluent can be an aqueous acid solution (e.g., HCl) that interacts with lithium complex 48 to release lithium 14 via ion exchange and forms a lithium salt that can be separated from extractant 46 (e.g., via gravity separation or other methods). Once separated, lithium 14 (e.g., a lithium salt) can be transferred from second separation vessel 34, via a first outlet 84a, for storage or further processing. In some configurations, extractant 46 can be transferred from second separation vessel 34, via a second outlet 84b, and recycled for use in subsequent. For example, second separation vessel 34 may include a return line 88 that is configured to recycle extractant 46.

Return line 88 can be in communication second separation vessel 34 and mixing vessel 22 to move fluid between the two vessels. As shown, the separated extractant 46 can be transferred out of second separation vessel 34, via second outlet 84b, to return line 88, and transferred into mixing vessel 22 (e.g., via second inlet 40b). The recycled extractant 46 can then be mixed with a second volume of brine 18, a second brine, or another solution. In some configurations, additional fluids may be added to return line 88 before extractant 46 is returned to mixing vessel 22. As an illustrative example, an additional volume of extractant 46 can be added to return line 88 after multiple extraction cycles. In some configurations, at least 95% (e.g., 98%, 99%, or more) of extractant can be recycled and additional extractant 46 can be added upon meeting a threshold number of cycles (e.g., between 100-300 cycles) or falling below a threshold volume. Additionally, or alternatively, an acid or base solution can be added to re-adjust the pH of extractant 46 after separation and before the extractant is introduced to a subsequent brine. Although not shown, return line 88 can include or be coupled to additional components, such as a reservoir, an inlet line, an actuation system, or other known component for processing fluid.

Some configurations of system 10 can include a control system 92 that is in electrical communication with one or more of the components of the system to perform at least one of the functions described above. For example, control system 92 can communicate with one or more valves to control the flow of fluid through system 10. Control system 92 can be connected to a network 96 for sending and receiving signals, data, or other information between system 10.

Although the vessels (e.g., 22, 26, 30, 34) in the depicted configuration are shown with a certain number of inlets and outlets, it should be understood that more or less inlets or outlets could be used. For example, each vessel may include a single inlet and a single outlet that may branch off in an upstream or downstream direction to transfer the fluid, as described above. Additionally, or alternatively, one or more of the vessels (e.g., 22, 26, 30, 34) can be combined or divided to have more or less vessels while performing the same functions.

As described herein, system 10 provides an improved system and method for the extraction of elements, such as lithium 14, from a solution. In some aspects, system 10 can eliminate the need for diluents, such as kerosene, during the extraction process. System 10 utilizes solutions that can be used for multiple extractions cycles, such as extractant 46, solvent 64, adsorbent media 60, or combination thereof. Some aspects of system 10 reduce the amount of equipment needed for the extraction process. Some aspects of system 10 increase the recovery of the targeted element (e.g., lithium 14) and can provide a higher concentrated end product with reduced contaminants. In this way and others, system 10 may reduce operating cost, simplify the operational process, and reduce the carbon footprint compared to traditional extraction systems. System 10 can also increase safety by recycling solutions, eliminating discharge or harmful components, and eliminating dangerous chemicals. Accordingly, system 10 and the processes described herein provide an advantage over the conventional systems and processes.

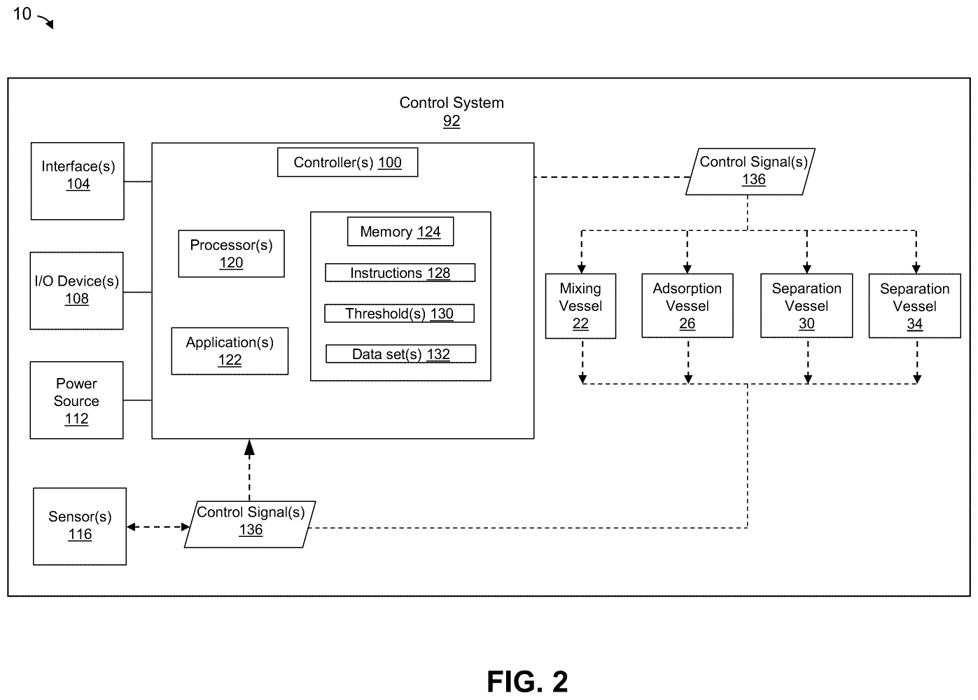

Referring now to FIG. 2, shown is a schematic diagram of system 10. As depicted, control system 92 can include a controller 100 configured to control one or more operations of system 10, such as, but not limited to, operation of the flow of fluid through vessels (22, 26, 30, 34), operation of inlets (40, 52, 68, 80), operation of outlets (42, 56, 72, 84), monitoring of flow parameters, chemical compositions, or the like (e.g., via sensors 116), or combination thereof. In the depicted configuration, control system 92 may comprise one or more interface(s) 104, one or more I/O device(s) 108, and a power source 112 coupled to controller 100. System 10 can include one or more sensor(s) 116 configured to detect one or more parameters and to provide data to controller 100 (e.g., via control signal 136). In some configurations, circuitry (e.g., a PCB, wires, etc.) may connect components of control system 92 with one or more other components of system 10.

Controller 100 may include a processor 120 coupled to a memory 124 (e.g., a computer-readable storage device). In some configurations, controller 100 may include one or more application(s) 122 that access processor 120 and/or memory 124 to operate system 10. Processor 120 may include or correspond to a microcontroller/microprocessor, a central processing unit (CPU), a field-programmable gate array (FPGA) device, an application-specific integrated circuits (ASIC), another hardware device, a firmware device, or any combination thereof. Memory 124, such as a non-transitory computer-readable storage medium, may include volatile memory devices (e.g., random access memory (RAM) devices), nonvolatile memory devices (e.g., read only memory (ROM) devices, programmable read-only memory, and flash memory), or both. Memory 124 may be configured to store instructions 128, one or more thresholds 130, one or more data sets 132, or combination thereof. In some configurations, instructions 128 (e.g., control logic) may be configured to, when executed by the one or more processors 120, cause the processor(s) to perform one or more operations (e.g., actuate valves on inputs and outputs of the vessels). The one or more thresholds 130 and one or more data sets 132 may be configured to cause the processor(s) to generate control signals (e.g., 136). For example, the processor(s) 120 may initiate and/or perform operations as described with reference to FIG. 1. As a specific example, thresholds can include a volume level of a vessel, a concentration of a solution, a pH of a solution, a number of cycles performed by system 10, a time, a pressure, a temperature, a flow velocity, or other fluid parameter within the system. Data sets 132 can include data associated with thresholds or other parameters of system 10, such as, data (e.g., chemical concentrations, pressures, temperatures, flow rates, or the like) from one or more previous extraction cycles.

Application(s) 122 may communicate (e.g., send and/or receive) with processor 120 and memory 124. For example, application(s) 122 may receive data from sensor(s) or memory 124 (e.g., data sets 132), manipulate the data, and send a signal to processor 120 to cause the processor to output the manipulated data (e.g., via interface 104 or I/O device 108) or store the manipulated data (e.g., via memory 124). In some configurations, application(s) 122 comprises COMSOL, ABAQUS, ImageJ, Matlab, Solidworks, AutoCAD, ANSYS, LabView, CATIA, OpenFoam, HFSS, Mathcad, combination thereof, or the like. In some configurations, controller 100 is configured to generate and send control signals 136. For example, controller 100 may generate and/or send control signals 136 responsive to receiving a signal and/or one or more user inputs via the one or more interfaces 104 and/or the one or more I/O devices 108.

Interfaces 104 may include a network interface and/or a device interface configured to be communicatively coupled to one or more other devices. For example, interfaces 104 may include a transmitter, a receiver, or a combination thereof (e.g., a transceiver), and may enable wired communication, wireless communication, or a combination thereof, such as with I/O device 108. The I/O device(s) 108 may include a touchscreen, a display device, a light emitting diode (LED), a speaker, a microphone, a camera, keyboard, computer mouse, another I/O device, or any combination thereof, as illustrative, non-limiting examples. In some configurations, interfaces(s) 104 and/or I/O device(s) 108 may enable a wired connection to controller 100 via a port or other suitable configuration.

Power source 112 may be coupled to controller 100, interface(s) 104, I/O device(s) 108, or combination thereof. In some configurations, power source 112 may be coupled to components of control system 92 via circuitry. In some configurations, power source 112 may include a battery, capacitors, a charge storage device, or the like. Although system 10 has been described as including interface(s) 104, I/O device(s) 108, and power source 112, in other configurations, the system may not include one or more of the interface(s), I/O device(s), or power source.

Sensor(s) 116 may be coupled to one or more components of system 10—including mixing vessel 22, adsorption vessel 26, first separation vessel 30, second separation vessel 34, return line 76, return line 88, or the inlets and outlets thereof. In some configurations, sensor(s) 116 are configured to determine parameters associated with fluid flow within system 10. For example, sensor(s) 116 can be configured to measure physical properties of the fluid (e.g., density, viscosity, temperature, pressure, specific weight, specific volume, specific gravity, or the like), surface tension, pulsatility, fluid pressure, fluid flow rate, fluid velocity, Doppler flow velocity, Reynolds number, stresses on fluid (e.g., shear velocity, shear stress, shear rate, yield stress, and the like), flow patterns, or the like. In some aspects, sensor(s) 116 may comprise flow meters, MEMS sensor, in-line fluidic sensor, pressure sensor, temperature sensor, mass flow sensors, ultrasonic sensors, level sensor, Infrared sensor, accelerometer, humidity sensor, or other suitable sensor.

In some configurations, instructions 128 (e.g., control logic) may be configured to, when executed by the one or more processors 120, cause the processor(s) to perform one or more operations. For example, the one or more operations may include receiving a message (e.g., control signal 136, a command, or an instruction) to perform an operation and identifying the requested operation. To illustrate, the operation may include mixing brine 18 with extractant 46 to form a solution containing lithium complex 48, extracting lithium 14 from the solution, and recycling extractant 46.

The one or more operations may also include initiating the operation based on the received message. To illustrate, initiating the operation may include generating and sending one or more control signals 136. For example, processor(s) 120 may send a control signal (e.g., 136) to mixing vessel 22 to actuate a mixer, to actuate one or more valves at inlet 40a, 40b or outlet 42, or combination thereof. As another example, processor(s) 120 may send a control signal (e.g., 136) to adsorption vessel 26 (e.g., to a valve or port thereof) to transfer fluid (e.g., impurities 16) through an outlet (e.g., 56a) at a first time. Additionally, or alternatively, processor(s) 120 may send a control signal (e.g., 136) to adsorption vessel 26 to transfer fluid (e.g., solvent 64) through an inlet (e.g., 52b) at a second time. Additionally, or alternatively, processor(s) 120 may send a control signal (e.g., 136) to adsorption vessel 26 to transfer fluid (e.g., the second solution) through an outlet (e.g., 56b) at a third time.

In some configurations, the one or more operations may include moving fluid into or out of first separation vessel 30 or second separation vessel 34. For example, processor(s) 120 may send a control signal (e.g., 136) to first separation vessel 30 (or component thereof) to decrease a pressure or increase a temperature of the first separation vessel to be above an evaporation threshold associated with solvent 64. In some configurations, processor(s) 120 may send a control signal (e.g., 136) to return line 76 (or component thereof) increase a pressure or decrease a temperature of the return line to be below an evaporation threshold associated with solvent 64. To further illustrate, processor(s) 120 may send a control signal (e.g., 136) to second separation vessel 34 or return line 88 to transfer fluid into and out of the second separation vessel. Additionally, or alternatively, any of mixing vessel 22, adsorption vessel 26, first separation vessel 30, second separation vessel 34, return line 76, return line 88, or the inlets and outlets thereof, may send may send a control signal (e.g., 136) to controller 100. For example, sensor(s) 116 may send a control signal (e.g., 136) to controller 100 (e.g., memory 124) to store data (e.g., 132) created by the sensor(s).

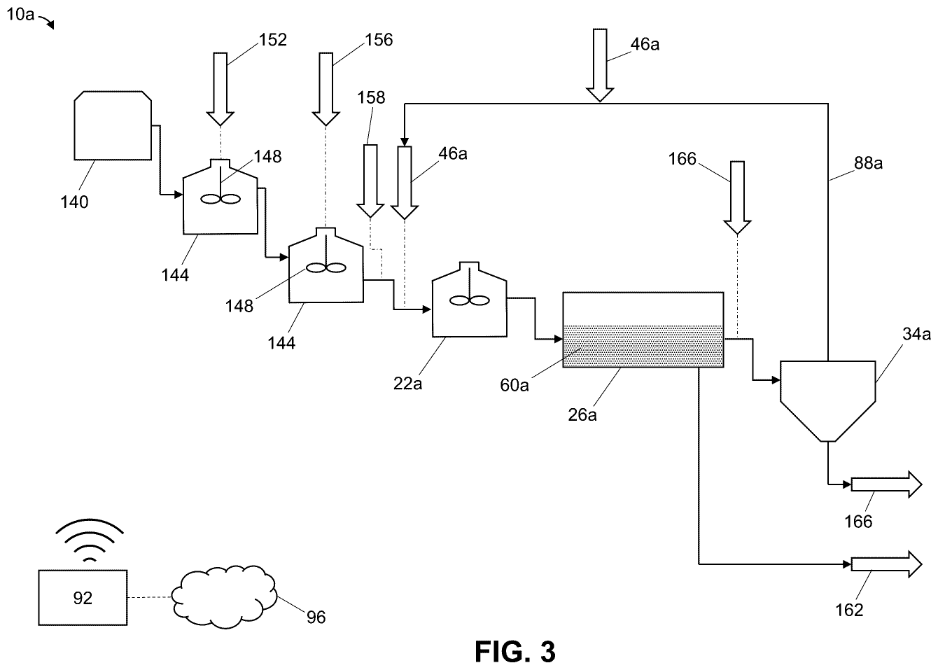

Referring now to FIG. 3, shown therein and designated by the reference numeral 10a is an example of another configuration of the present system. In system 10a, components that are similar, such as in structure or function, to components discussed with reference to FIG. 1 are labeled with the same reference numerals and a new numeral suffix, for example “a.” These similar components of system 10a may include or correspond to the matching components of system 10.

System 10a may be utilized to carry out an extraction process, such as the extraction of lithium (e.g., 14) from a brine (e.g., 18). In some configurations, system 10a can include a brine source 140 and one or more pre-treatment vessels 144. As depicted, system 10a includes two pre-treatment vessels 144, however, more or less pre-treatment vessels can be used in other configurations. Brine source 140 may include or correspond to a reservoir (e.g., tank) configured to store a brine, such as a saltwater brine, geothermal brine, or the like. In some configurations, brine source 140 can be connected to an underground well and receive brine from the well and, in other configurations, the brine can be delivered to the brine source from other places, such as additional storage tanks or transport vehicles.

Pre-treatment vessels 144 can be in communication with brine source 140 and are configured to process the brine (e.g., via filtration, ion exchange, purification, or the like). As shown in FIG. 3, each pre-treatment vessel 144 may include a mixer 148; however, in other configurations, the pre-treatment vessels can include additional or alternative components, such as a filtration or purification device. In some configurations, additives can be mixed into the brine in pre-treatment vessel 144. For example, a first additive 152 may be added to a first pre-treatment vessel (e.g., 144) and a second additive 156 may be added to a second pre-treatment vessel (e.g., 144). First and second additives 152, 156 can be the same or different chemicals and can include lime, soda ash, or the like.

System 10a includes a mixing vessel 22a, an adsorption vessel 26a, a separation vessel 34a, and a return line 88a. Mixing vessel 22a is in fluid communication with brine source 140 or pre-treatment vessels 144 to receive the brine and is configured to mix the brine (e.g., 18) with an extractant 46a. As depicted in FIG. 3, extractant 46a can be introduced to the brine outside of mixing vessel 22a, such as, for example, within the piping. In some configurations, a pH additive 158 can be introduced with extractant 46a. As a non-limiting example, pH additive 158 can include a suitable acid such as, HCl, H2SO4, HNO3, or a suitable base, such as NaOH and KOH. Mixing vessel 22a is configured to agitate the brine and extractant 46a such that a chemical complex (e.g., 48) is formed having a target element (e.g., lithium 14) bound to the extractant.

Adsorption vessel 26a includes an adsorbent media 60a and is configured to receive the mixed fluid from mixing vessel 22a. The chemical complex interacts with adsorbent media 60a such that the complex is adsorbed onto the media and can be held in place while excess fluid 162 is drained from the adsorption vessel. In this way and others, the chemical complex can be separated from the brine. After the chemical complex is isolated, the chemical complex can be discharged from the adsorption vessel 26a. In some configurations, one or more other chemicals, such as a solvent, can be added to adsorption vessel 26a during the separation process, as described herein. In some such configurations, the additional chemicals can be drained similarly to excess fluid 162 or can be transferred from adsorption vessel 26a with the chemical complex.

Separation vessel 34a is configured to receive the chemical complex from adsorption vessel 26a and separate the target element (e.g., 170) from extractant 46a. As depicted in FIG. 3, an additive 166 can be introduced to the chemical complex outside of separation vessel 34a. Additive 166 can include an acidic composition such as nitric acid, hydrochloric acid, sulfuric acid, formic acid, acetic acid, chloric acid or a combination thereof. In some configurations, separation vessel 34a may include a precipitation filter, such as a strainer, membrane, or other material configured to separate solids from a liquid. For example, in some configurations, a concentration of the target element (e.g., lithium 14) can be in the form of a solid and the remaining chemicals can be separated from the remaining fluid via the precipitation filter. After separation, target element 170 can be transferred from separation vessel 34a for storage, shipping, or further processing. In some configurations, target element 170 can be in the form of a compound that includes the target element, such as a salt (e.g., LiCl).

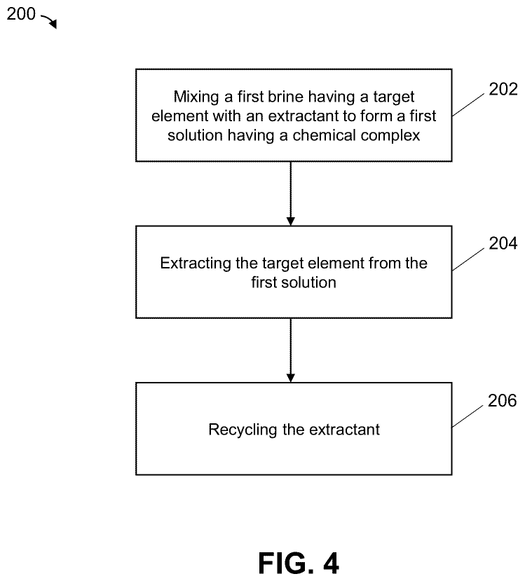

Referring now to FIG. 4, a method 200 of extracting a target element, such as lithium, is shown. In some configurations, method 200 is performed by or at system 10, 10a. As shown, method 200 includes mixing a first brine having a target element with an extractant to form a first solution having a chemical complex, at step 202. In some configurations, the target element is lithium and the extractant is an acidic extractant such as a phosphoric extractant, phosphinic extractant, or a phosphonic extractant. In some such methods, the chemical complex includes a lithium complex having lithium bound to the extractant. In some configurations, the mixing step may be performed at a mixing vessel (e.g., 22, 22a).

Method 200 further includes extracting the target element from the first solution, at step 204. In some methods, extracting the target element includes adsorbing, via an adsorbent media, the chemical complex from the first fluid, removing the chemical complex from the adsorbent media; and separating the target element from the extractant in the chemical complex. Removing the chemical complex from the adsorbent media can include, at least, introducing the adsorbent media to a solvent to displace the chemical complex from the adsorbent media; separating the adsorbent media from the solvent and the chemical complex; and evaporating the solvent from the chemical complex. The solvent can have a higher vapor pressure than the extractant to assist in evaporation of the solvent. In some methods, separating the target element from the extractant includes introducing the chemical complex to an acidic wash. In some configurations, the extracting step may be performed at a adsorption vessel (e.g., 26, 26a), a separation vessel (e.g., 30, 34a), or both.

Method 200 further includes recycling the extractant, at step 206. In some methods, recycling the extractant can include transporting the extractant from a separation vessel (e.g., 34, 34a) to a mixing vessel (e.g., 22, 22a) for use in a subsequent extraction process (e.g., second extracting step). For example, some methods include mixing the recycled extractant with a second brine having a target element to form a second mixed solution including a chemical complex having the target element chemically bound to the extractant. Some such methods, further include the step of extracting the target element from the second mixed solution. Some methods include recycling the extractant to be used in a third extracting step.

It is noted that in some implementations, method 200 may include one or more operations as described with reference to control system 92. Additionally, or alternatively, control system 92 may be utilized to perform one or more steps of the aforementioned methods (e.g., 200). It is also noted that the systems and methods described herein are not limited to the extraction of any particular element and may be utilized for the extraction or separation of various elements such as rare earth metals, alkali metals, or other metals or elements. A non-inclusive, illustrative list of elements can include lanthanum, cerium, praseodymium, neodymium, promethium, samarium, europium, gadolinium, terbium, dysprosium, holmium, erbium, thulium, ytterbium, lutetium, scandium, and yttrium, magnesium, sodium, potassium, rubidium.

### EXAMPLES

The present invention will be described in greater detail by way of specific examples. The following examples are offered for illustrative purposes only and are not intended to limit the invention in any manner. Those of skill in the art will readily recognize a variety of noncritical parameters that can be changed or modified to yield essentially the same results.

### Example 1

### Recovery of Lithium from LiCl Brine Solution Using Diluent

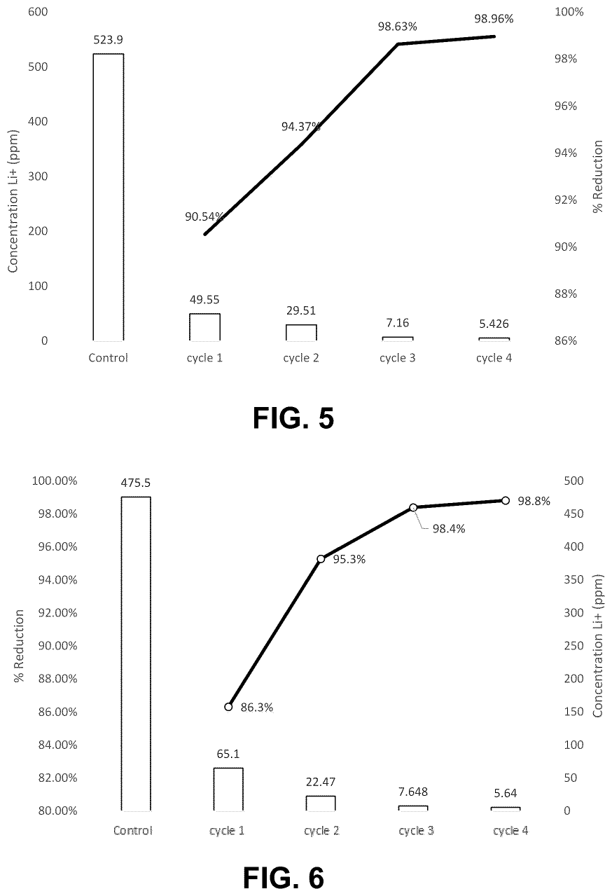

A stock solution of Cyanex 936P and diluent 28% (v/v) was prepared using metallurgical grade Kerosene as the diluent, hereinafter “Cyanex 28%.” A 240 mL LiCl solution was prepared at 3000 ppm and 40 mL of this solution was sent for inductively coupled plasma mass spectrometry (ICP-MS) analysis and a lithium concentration of 523.9 (ppm of Li+) was found. The remaining 200 mL of the LiCl solution was mixed with 60 mL of Cyanex 28% and 1.72 mL of NaOH 10M for 4 minutes. The mixed solution was pumped through a 15 g Osorb bed at a flow rate of 9.0 mL/min. After being pumped through the Osorb bed, 40 mL of an outlet sample (first outlet sample—sample no. 1007.56) was sent for ICP-MS analysis. As shown in Table 1 and FIG. 5, the lithium concentration of the first outlet sample was found to be 49.55 (ppm of Li+), resulting in a 90.54% reduction in lithium. Thus, it is shown that a significant amount of Lithium can be captured by the Osorb bed and may be extracted using further processing.

For cycle 2, 160 mL of the first outlet sample was mixed with 48 mL of Cyanex 28% and 1.38 mL of NaOH 10M for 4 minutes and pumped through a new Osorb bed (15 g) at a flow rate of 9.0 mL/min. From the outlet solution, a 40 mL sample (second outlet sample—sample no. 1007.57) was sent for ICP-MS analysis. The lithium concentration of the second outlet sample was found to be 29.51 (ppm of Li+), resulting in a 94.37% reduction in lithium as compared to the initial LiCl solution. This cycles was repeated two more times as shown in Table 1, below.

TABLE 1
Test Results for Recovery of Lithium using Diluent

| | | | | Cyanex + | | | | |
|---|---|---|---|---|---|---|---|---|
| | | Inlet solution | | diluent | NaOH | | | |
| | Sample | Concentration | Volume | added | 10M | pH | Li+ | Reduction |
| | number | (ppm) | (mL) | (mL) | (mL) | noted | (ppm) | (%) |
| Control | 1007.55 | — | 240 | — | — | — | 523.9 | — |
| Cycle 1 | 1007.56 | 523.9 | 200 | 60 | 1.72 | 9.80 | 49.55 | 90.54% |
| Cycle 2 | 1007.57 | 49.55 | 160 | 48 | 1.38 | 10.12 | 29.51 | 94.37% |
| Cycle 3 | 1007.58 | 29.51 | 120 | 36 | 1.03 | 11.06 | 7.16 | 98.63% |
| Cycle 4 | 1007.59 | 7.16 | 80 | 24 | 0.69 | 10.95 | 5.426 | 98.96% |

For cycle 3, 36 mL of Cyanex 28% and 1.03 mL of NaOH 10M was added to 120 mL of the outlet solution from cycle 2 and pumped through a new Osorb bed, as described above. For cycle 4, 24 mL of Cyanex 28% and 0.69 mL of NaOH 10M was added to 80 mL of the outlet solution from cycle 3 and pumped through a new Osorb bed, as described above. A 40 mL sample was taken for each outlet solution and sent for ICP-MS analysis. For cycle 3, a third outlet sample (sample no. 1007.58) was found to have a lithium concentration of 7.16 (ppm of Li+), resulting in a 98.63% reduction in lithium from the initial solution. For cycle 4, a third outlet sample (sample no. 1007.59) was found to have a lithium concentration of 5.426 (ppm of Li+), resulting in a 98.63% reduction in lithium from the initial solution. Thus, as shown in Table 1 above and FIG. 5, the % of Li ion reduction for Example 1 was 90.54% for the first cycle, 94.37% for the second cycle, 98.63% for the third cycle and 98.96% for the fourth cycle.

The 15 g Osorb bed from Cycle 1 was removed and tested after the mixed solution was pumped through the bed, as described above. The testing results are shown in Table 2, below.

TABLE 2
Test Results of Recovery of Lithium from Adsorbent Media

| Parameter | Value | Unit | Note |
|---|---|---|---|
| Li Concentration adsorbed | 474.35 | mg/L | As measured by external |
| in 15 g of Osorb | | | lab |
| Inlet water volume | 40 | mL | Collected during |
| processed | | | experiment |
| mass of Osorb used | 15 | g | Fixed quantity for testing |
| mass of Osorb cleaned | 1.252 | g | As measured internally |
| | | | during experiment |
| Volume of liquid recovered | 40 | mL | Collected during |
| | | | experiment |
| concentration of lithium in | 42.68 | mg/L | As measured by external |
| recovered liquid | | | laboratory |
| mg of Li recovered | 1.71 | mg | Calculated |
| mg of Lithium recovered/g | 1.36 | mg/L | Calculated |
| Osorb | | | |
| mg of Lithium processed | 18.97 | mg | Calculated |
| mg of lithium process/g | 1.26 | mg/g | Calculated |
| Osorb | | | |
| recovery rate | 108% | % | Calculated |

As shown, in FIG. 5, the lithium concentration decreased from 523.9 ppm (equivalent to mg/L) to 49.55 ppm during cycle 1. A concentration of 474.35 ppm was adsorbed in the Osorb for the inlet volume of 40 mL yielding 18.97 mg of processed lithium in the 15 g of Osorb at 1.26 mg of lithium per gram of Osorb. A 1.252 gram sample of the processed Osorb was then cleaned with 40 mL of liquid to determine the actual amount of lithium captured by the Osorb. A concentration of lithium in the recovered liquid was determined to be 42.68 mg/L. Based on the mass of the Osorb sample, the mass of the lithium recovered (1.71 mg Li) and the recovery concentration (1.26 mg Li/g Osorb) were calculated. Comparing the sample of cleaned Osorb to the processed Osorb, it is found that the recovery rate for the sample is 108% of the processed rate. This calculation is likely the result of the a difference in an adsorbed lithium concentration between the sample Osorb and the processed Osorb. Thus, the sample Osorb likely has a higher concentration of lithium (Li/gram of media) as compared to the total processed Osorb 15 g.

### Example 2

### Recovery of Lithium from LiCl Brine Solution without Diluent with Reused Media

A 240 mL LiCl solution was prepared at 3000 ppm and 40 mL of this solution was sent for ICP-MS analysis. A lithium concentration of the solution (sample 1007.64) was found to be 476 (ppm of Li+). The remaining 200 mL of the LiCl solution was mixed with 16.80 mL of Cyanex 936P and 1.72 mL of NaOH 10M for 4 minutes and pumped through a 15 g Osorb bed at a flow rate of 9.0 mL/min. From the outlet solution, a 40 mL sample (first outlet sample—sample no. 1007.65) was sent for ICP-MS analysis. The lithium concentration of the first outlet sample was found to be 65.1 (ppm of Li+), resulting in a 86.3% reduction in lithium.

Accordingly, by using the systems and methods described herein, a suitable amount of lithium may be captured by an absorbent media without the use of diluents. Further, in Example 2 only 16.80 mL of extractant (e.g., Cyanex 936P) was used for the extraction process, much less than the 60 mL of extractant + diluent used in Example 1. In this way, the above systems and process can reduce an amount of chemicals used during extraction without sacrificing efficiency. The can increase both safety and profitability of extraction operations.

After the first cycle, the Osorb media bed was regenerating using liquified petroleum gas. The regenerated Osorb was then reused for cycle 2. In cycle 2, 13.44 mL of Cyanex 936P and 1.38 mL of NaOH 10M was added to 160 mL of the outlet solution from cycle 1 and pumped through the regenerated Osorb bed at a flow rate of 9.0 mL/min. From the outlet solution of cycle 2, a 40 mL sample (second outlet sample—sample no. 1007.66) was sent for ICP-MS analysis. The lithium concentration of the second outlet sample was found to be 22.47 (ppm of Li+), resulting in a 95.3% reduction in lithium as compared to the initial LiCl solution. The Osorb media bed was then regenerated again using liquified petroleum gas. The above described cycle was repeated two times as shown in Table 3, below.

TABLE 3
Test Results for Recovery of Lithium without Reused Media

| | | Inlet solution | | Cyanex | NaOH | | | |
|---|---|---|---|---|---|---|---|---|
| | Sample | Concentration | Volume | added | 10M | pH | Li+ | Reduction |
| | number | (ppm) | (mL) | (mL) | (mL) | noted | (ppm) | (%) |
| Control | 1007.64 | | 240 | — | — | — | 475.5 | — |
| Cycle 1 | 1007.65 | 475.5 | 200 | 16.80 | 1.72 | 11.70 | 65.1 | 86.3% |
| Cycle 2 | 1007.66 | 65.1 | 160 | 13.44 | 1.38 | 12.40 | 22.47 | 95.3% |
| Cycle 3 | 1007.67 | 22.47 | 120 | 10.08 | 1.03 | 12.45 | 7.648 | 98.4% |
| Cycle 4 | 1007.68 | 7.648 | 80 | 6.72 | 0.69 | 12.05 | 5.64 | 98.8% |

For cycle 3, 10.08 mL of Cyanex 936P and 1.03 mL of NaOH 10M was added to 120 mL of the outlet solution from cycle 2 and pumped through the regenerated Osorb bed, as described above. For cycle 4, the Osorb media was regenerated and 6.72 mL of Cyanex 936P and 0.69 mL of NaOH 10M was added to 80 mL of the outlet solution from cycle 3 and pumped through the regenerated Osorb bed, as described above. A 40 mL sample was taken for each outlet solution and sent for ICP-MS analysis. For cycle 3, a third outlet sample (sample no. 1007.67) was found to have a lithium concentration of 7.648 (ppm of Li+), resulting in a 98.4% reduction in lithium from the initial solution. For cycle 4, a third outlet sample (sample no. 1007.68) was found to have a lithium concentration of 5.64 (ppm of Li+), resulting in a 98.8% reduction in lithium from the initial solution. Thus, as shown in Table 3 above and FIG. 6, the % of Li ion reduction for Example 2 was 86.3% for the first cycle, 95.3% for the second cycle, 98.4% for the third cycle and 98.8% for the fourth cycle.

### Example 3

### Recovery of Lithium from LiCl Brine Solution Recycled Media and Extractant

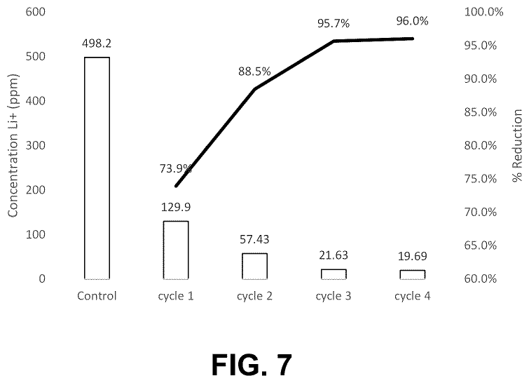

A 240 mL LiCl solution was prepared at 3000 ppm and 40 mL of this solution was sent for ICP-MS analysis. A lithium concentration of the solution (sample 1007.73) was found to be 498.2 (ppm of Li+). The remaining 200 mL of the LiCl solution was mixed with 16.80 mL of Cyanex 936P and 1.72 mL of NaOH 10M for 4 minutes and pumped through a 15 g Osorb bed at a flow rate of 9.0 mL/min. From the outlet solution, a 40 mL sample (first outlet sample—sample no. 1007.74) was sent for ICP-MS analysis. The lithium concentration of the first outlet sample was found to be 129.9 (ppm of Li+), resulting in a 73.9% reduction in lithium. As shown in FIGS. 6 and 7, the lithium reduction rate is much lower for Example 3 than for Example 2, despite the fact that the processes were nearly identical. This is likely due to normal deviation from testing and is not contributed to the recycled media or extractant.

After the first cycle, the Osorb media bed was regenerating using liquified petroleum gas. The Cyanex 936P was also recaptured from outlet solution so that it could be reused for cycle 2. In cycle 2, 13.44 mL of recycled Cyanex 936P and 1.38 mL of NaOH 10M was added to 160 mL of the outlet solution from cycle 1 and pumped through the regenerated Osorb bed at a flow rate of 9.0 mL/min. From the outlet solution of cycle 2, a 40 mL sample (second outlet sample—sample no. 1007.75) was sent for ICP-MS analysis. The lithium concentration of the second outlet sample was found to be 57.43 (ppm of Li+), resulting in a 88.5% reduction in lithium as compared to the initial LiCl solution. As can be seen by the difference between cycle 1 and cycle 2, the lithium recovery using recycled adsorbent media and extractant is similar to that shown in Example 1 and Example 2. Thus, despite the lower initial lithium reduction, it appears that the further reductions using the recycled adsorbent media and extractant have no negative effects on the lithium capture.

The Osorb media bed was then regenerated using liquified petroleum gas and the Cyanex 936P was recaptured from outlet solution. The above described cycle was repeated two times as shown in Table 4, below.

TABLE 4
Test Results for Recovery of Lithium with Recycled Media and Extractant

| | | Inlet solution | | Cyanex | NaOH | | | |
|---|---|---|---|---|---|---|---|---|
| | Sample | Concentration | Volume | added | 10M | pH | Li+ | Reduction |
| | number | (ppm) | (mL) | (mL) | (mL) | noted | (ppm) | (%) |
| Control | 1007.73 | | 240 | — | — | — | 498.2 | — |
| Cycle 1 | 1007.74 | 498.2 | 200 | 16.80 | 1.72 | 11.50 | 129.9 | 73.9% |
| Cycle 2 | 1007.75 | 129.9 | 160 | 13.44 | 1.38 | 12.20 | 57.43 | 88.5% |
| Cycle 3 | 1007.76 | 57.43 | 120 | 10.08 | 1.03 | 12.60 | 21.63 | 95.7% |
| Cycle 4 | 1007.77 | 21.63 | 80 | 6.72 | 0.69 | 12.50 | 19.69 | 96.0% |

For cycle 3, 10.08 mL of recycled Cyanex 936P and 1.03 mL of NaOH 10M was added to 120 mL of the outlet solution from cycle 2 and pumped through the regenerated Osorb bed, as described above. The Osorb media and Cyanex 936P were, again, recovered. For cycle 4, 6.72 mL of the recycled Cyanex 936P and 0.69 mL of NaOH 10M was added to 80 mL of the outlet solution from cycle 3 and pumped through the regenerated Osorb bed, as described above. A 40 mL sample was taken for each outlet solution and sent for ICP-MS analysis. For cycle 3, a third outlet sample (sample no. 1007.76) was found to have a lithium concentration of 21.63 (ppm of Li+), resulting in a 95.7% reduction in lithium from the initial solution. For cycle 4, a third outlet sample (sample no. 1007.68) was found to have a lithium concentration of 19.69 (ppm of Li+), resulting in a 96.0% reduction in lithium from the initial solution. Thus, as shown in Table 4 above and FIG. 7, the % of Li ion reduction for Example 3 was 73.9% for the first cycle, 88.5% for the second cycle, 95.7% for the third cycle and 96% for the fourth cycle.

### Example 4

### Recovery of Samarium and Cobalt

A chlorine and a nitrate solution were prepared by dissolving scrap Samarium-Cobalt magnet material in HCl or HNO3, respectively. Each solution was adjusted to a pH of 3.0 by adding aqueous NH₃. For each of the Chlorine (Cl⁻) and Nitrate (NO₃⁻) solution, the concentration of Samarium was measured to be 350 ppm Sm3⁺ and the concentration of Cobalt was measured to be 750 ppm Co²⁺. The solutions were then mixed with various extractants and pumped through a Osorb bed to produce an outlet sample, as described in the methods above. The percentage of reduction in to elements was then measured to determine the amount of extraction.

Using mono-2-ethylhexyl-(2-ethylhexyl) phosphonic acid (MEHEHP) as the extractant, it was found that 99.9% of the Samarium (Sm³⁺) was extracted for both the chlorine and nitrate solutions and 58.6% and 56.1% of the Cobalt (Co²⁺) was extracted for the chlorine solution and nitrate solution, respectively.

The extraction percentage of Samarium was also measured using three other extractants: di-2-ethylhexyl phosphoric acid (DEHPA), 2-[(1Z)-1-(hydroxyamino)ethyl]-4-nonylphenol (LIX 84I), and tri-n-butyl phosphate (TBP). Using DEHPA as the extractant, at least 99.9% of Samarium was removed from both solutions. Using LIX 84I as the extractant, at least 59.7% of Samarium was removed from both solutions. Using TBP as the extractant, at least 67.5% of Samarium was removed from both solutions. Accordingly, the systems and methods described herein, can provide very high levels of extractions for metals, and particularly for rare earth metals, with various extractants.

Although there appears to be some variance, FIGS. 5-7 show the present system and methods are viable options for lithium extraction, even without the use of diluents. Further, by reusing adsorbent material and recycling extractants less chemicals are needed without a significant drop off in lithium capture. For example, as shown in FIG. 5, Example 1 illustrates a lithium reduction from 49.55 in cycle 1 to 29.51 in cycle 2, a 40.44% reduction in lithium concentration. Referring now to FIG. 7, a similar lithium reduction can be found between cycle 2 and cycle 3, where a lithium reduction from 57.43 in cycle 2 to 21.36 in cycle 3 occurs—a 62.34% reduction. Despite reusing both the adsorbent media and the extractant, a greater amount of lithium is captured at similar concentration levels.

The above specification and examples provide a complete description of the structure and use of illustrative configurations. Although certain configurations have been described above with a certain degree of particularity, or with reference to one or more individual configurations, those skilled in the art could make numerous alterations to the disclosed configurations without departing from the scope of this invention. As such, the various illustrative configurations of the methods and systems are not intended to be limited to the particular forms disclosed. Rather, they include all modifications and alternatives falling within the scope of the claims, and configurations other than the one shown may include some or all of the features of the depicted configurations. For example, elements may be omitted or combined as a unitary structure, connections may be substituted, or both. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one configuration or may relate to several configurations. Accordingly, no single implementation described herein should be construed as limiting and implementations of the disclosure may be suitably combined without departing from the teachings of the disclosure.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims. The claims are not intended to include, and should not be interpreted to include, means-plus- or step-plus-function limitations, unless such a limitation is explicitly recited in a given claim using the phrase(s) “means for” or “step for,” respectively.

1. A method of extracting lithium, the method comprising:
mixing a first brine having lithium with an extraction agent to form a first fluid having a lithium complex, the lithium complex including lithium bound to the extraction agent;
extracting the lithium from the first fluid, wherein the extracting step comprises:
adsorbing, via an adsorbent media, the lithium complex from the first fluid;
removing the lithium complex from the adsorbent media; and
separating the lithium from the extraction agent in the lithium complex; and
recycling the extraction agent and the adsorbent media to be used in a further extracting step.

2. The method of claim 1, further comprising mixing a second brine having lithium with the recycled extraction agent to form a second fluid having the lithium complex.

3. The method of claim 2, further comprising extracting the lithium from the second fluid, wherein the extracting step comprises:
adsorbing, via the adsorbent media, the lithium complex from the second fluid;
removing the lithium complex from the adsorbent media; and
separating the lithium from the extraction agent in the lithium complex.

4. The method of claim 2, further comprising recycling the extraction agent and the adsorbent media to be used in a further extracting step.

5. The method of claim 1, wherein the adsorbent media includes a mesoporous silica media.

6. The method of claim 1, wherein the extraction agent includes an acidic extractant or a neutral extractants.

7. The method of claim 1, wherein removing the lithium complex from the adsorbent media includes:
introducing the adsorbent media to a solvent to displace the lithium complex from the adsorbent media;
separating the adsorbent media from the solvent and lithium complex; and
evaporating the solvent from the lithium complex.

8. The method of claim 7, further comprising recycling the solvent to be used in a further extracting step.

9. The method of claim 7, wherein the solvent has a vapor pressure that is greater than a vapor pressure of the extracting agent.

10. The method of claim 1, wherein separating the lithium from the extraction agent in the lithium complex includes introducing the lithium complex to an acid.

11. The method of claim 1, wherein the method of extracting lithium is performed without kerosene.

12. A method for recovering an earth metal ion from groundwater, the method comprising:
receiving, at a first vessel, a first brine having an earth metal;
receiving, at the first vessel, an extracting agent;
forming, at the first vessel, a first solution having a first composition that includes the earth metal and the extracting agent
introducing, at a second vessel, the first solution to a plurality of porous silica adsorbents such that the first composition is adsorbed onto the porous silica adsorbents;
removing the first composition from the porous silica adsorbents;
separating the earth metal from the extracting agent in the first composition;
processing the earth metal; and
transporting the extracting agent to the first vessel.

13. The method of claim 12, wherein the earth metal is lithium and further comprising:
receiving, at the first vessel, a second brine having lithium; and
forming, at the first vessel, a second solution having the first composition;
extracting the lithium from the first composition; and
transporting the extracting agent to the first vessel.

14. The method of claim 12, wherein removing the first composition from the porous silica adsorbents includes mixing, at the second vessel, the porous silica adsorbents with a solvent to form a second solution and transferring the second solution to a third vessel.

15. The method of claim 14, further comprising:
evaporating, at the third vessel, the solvent to form a third solution; and
recycling the solvent;
wherein the third solution includes the first composition.

16. The method of claim 15, wherein a concentration of the first composition in the third solution is greater than 98%.

17. The method of claim 12, wherein separating the earth metal from the extracting agent in the first composition includes modifying a pH of the first composition.

18. A system for extracting an earth metal ion, the system comprising:
a first vessel having:
an inlet configured to receive:
a first brine having an earth metal; and
an extractant; and
a mixer configured to mix the first brine with the extractant to form a first solution having an earth metal complex, the earth metal complex including the earth metal bonded to the extractant;
a second vessel having:
an inlet configured to receive the first solution from the first vessel,
a porous silica media configured to adsorb the earth metal complex from the first solution; and
a first outlet configured to discharge the first solution after the earth metal complex is adsorbed on the porous silica media; and
a second outlet configured to discharge a second solution having the earth metal complex and a solvent;
a third vessel having:
an inlet configured to receive the second solution from the second outlet of the second vessel;
a first outlet configured to discharge the earth metal complex from the third vessel; and
a second outlet configured to discharge the solvent from the third vessel;
a fourth vessel having:
an inlet configured to receive the earth metal complex from the first outlet of the third vessel; and
a first outlet configured to discharge the extractant from the earth metal complex;
a second outlet configured to discharge the earth metal from the earth metal complex; and
a first return line coupled to the first outlet of the first vessel and in fluid communication with the first vessel, the first return line configured to recycle the extractant from the fourth vessel to the first vessel.

19. The system of claim 18, wherein the earth metal is lithium and the first vessel is configured to receive the extractant from the first return line and receive a second brine having lithium from a fifth vessel.

20. The system of claim 18, further comprising a second return line coupled to the second outlet of the third vessel and in fluid communication with the second vessel, the second return line configured to recycle the solvent from the third vessel to the second vessel.
